(19) United States
(12) Patent Application Publication
(10) Pub. No.: US 2026/0095975 A1
(43) Pub. Date: Apr. 2, 2026

(54) DETERMINING A MONITORING WINDOW FOR CONTROL INFORMATION

(71) Applicant: Lenovo (Singapore) Pte. Ltd., Singapore (SG)

(72) Inventors: Hossein Bagheri, Dearborn Heights, MI (US); Vijay Nangia, Woodridge, IL (US); Hyejung Jung, Northbrook, IL (US); Joachim Löhr, Wiesbaden (DE); Prateek Basu Mallick, Dreieich (DE)

(21) Appl. No.: 19/113,155

(22) PCT Filed: Sep. 27, 2023
(86) PCT No.: PCT/IB2023/059632

§ 371 Date: Mar. 19, 2025

Related U.S. Application Data
(60) Provisional application No. 63/410,511, filed on Sep. 27, 2022.

(51) Int. Cl. H04W 76/28; H04W 52/02; H04W 72/232

(52) U.S. Cl. CPC H04W 76/28; H04W 52/0225; H04W 72/232

(57) ABSTRACT

Apparatuses, methods, and systems are disclosed for determining a monitoring window for control information. One method (1400) includes receiving (1402) a DRX configuration for a set of non-uniform DRX cycles. The set of non-uniform DRX cycles occurs according to a pattern that periodically repeats, and at least two DRX cycles of the set of non-uniform DRX cycles have different durations. The method (1400) includes determining (1404) a first set of DRX cycles based on the DRX configuration. The method (1400) includes receiving (1406) a search space configuration associated with monitoring a DCI format. DCI of the DCI format is to be monitored for a PDCCH monitoring window of time outside of an active time of a DRX cycle. The method (1400) includes receiving (1408) a DCP configuration for monitoring the DCI format.

### FIELD

The subject matter disclosed herein relates generally to wireless communications and more particularly relates to determining a monitoring window for control information.

### BACKGROUND

In certain wireless communications systems, a downlink channel may be monitored. In such systems, the monitoring may occur outside of an active time period.

### BRIEF SUMMARY

Methods for determining a monitoring window for control information are disclosed. Apparatuses and systems also perform the functions of the methods. One embodiment of a method includes receiving, at a user equipment (“UE”), a discontinuous reception (“DRX”) configuration for a set of non-uniform DRX cycles. The set of non-uniform DRX cycles occurs according to a pattern that periodically repeats, and at least two DRX cycles of the set of non-uniform DRX cycles have different durations. In some embodiments, the method includes determining a first set of DRX cycles based on the DRX configuration. In certain embodiments, the method includes receiving a search space configuration associated with monitoring a downlink control information (“DCI”) format. DCI of the DCI format is to be monitored for a physical downlink control channel (“PDCCH”) monitoring window of time outside of an active time of a DRX cycle. In various embodiments, the method includes receiving a DCI configuration for monitoring the DCI format, where in a DCI associated with the DCI configuration has a cyclic redundancy check (“CRC”) scrambled by a power saving (“PS”) radio network temporary identifier (“RNTI”) (“PS-RNTI”) (“DCP”). In some embodiments, the method includes determining a PDCCH monitoring window for the DCI format for each DRX cycle of the first set of DRX cycles. The PDCCH monitoring window for each DRX cycle is determined based on: a periodicity of the search space configuration, an offset of the search space configuration, or a combination thereof; a start of an on-duration timer for the corresponding DRX cycle; the DCP configuration; or a combination thereof. The at least two DRX cycles of the first set of DRX cycles have different attributes for the PDCCH monitoring window, and the attributes comprise a window duration, a relative window location with respect to a start of a DRX on-duration, or a combination thereof.

One apparatus for determining a monitoring window for control information includes a processor. In some embodiments, the apparatus includes a memory coupled with the processor, the processor configured to cause the apparatus to: receive a DRX configuration for a set of non-uniform DRX cycles, wherein the set of non-uniform DRX cycles occurs according to a pattern that periodically repeats, and at least two DRX cycles of the set of non-uniform DRX cycles have different durations; determine a first set of DRX cycles based on the DRX configuration; receive a search space configuration associated with monitoring a DCI format, wherein DCI of the DCI format is to be monitored for a PDCCH monitoring window of time outside of an active time of a DRX cycle; receive DCP configuration for monitoring the DCI format; and determine a PDCCH monitoring window for the DCI format for each DRX cycle of the first set of DRX cycles. The PDCCH monitoring window for each DRX cycle is determined based on: a periodicity of the search space configuration, an offset of the search space configuration, or a combination thereof; a start of an on-duration timer for the corresponding DRX cycle; the DCP configuration; or a combination thereof. The at least two DRX cycles of the first set of DRX cycles have different attributes for the PDCCH monitoring window, and the attributes include a window duration, a relative window location with respect to a start of a DRX on-duration, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining a monitoring window for control information;

FIG. 2 is a schematic block diagram illustrating one embodiment of an apparatus that may be used for determining a monitoring window for control information;

FIG. 3 is a schematic block diagram illustrating one embodiment of an apparatus that may be used for determining a monitoring window for control information;

FIG. 4 is a schematic block diagram illustrating one embodiment of a system for short DRX and long DRX operation;

FIG. 5 is a schematic block diagram illustrating one embodiment of a system for wake up signal (“WUS”) monitoring within a PS-offset window including two search space sets containing monitoring occasions for WUS;

FIG. 6 is a schematic block diagram illustrating one embodiment of a system for WUS monitoring for long DRX cycle #2 within PS-offset window including two search space sets containing monitoring occasions for WUS, and for long DRX cycle #2 within PS-offset window including one search space set which contains monitoring occasions for WUS;

FIG. 7 is a schematic block diagram illustrating one embodiment of a system in which a MinTimeGap shortens the PDCCH monitoring window prior to a DRX on-duration;

FIG. 8 is a schematic block diagram illustrating one embodiment of a system in which a non-uniform DRX pattern repeats every 100 ms;

FIG. 9 is a schematic block diagram illustrating one embodiment of a system in which there is non-uniform PDCCH monitoring for non-uniform DRX cycles;

FIG. 10 is a schematic block diagram illustrating one embodiment of a system in which WUS is monitored in three search space sets, each with new search space set periodicity of 100 ms, and duration of 4 ms;

FIG. 11 is a schematic block diagram illustrating one embodiment of a system for monitoring 9 DRX cycles and the corresponding PDCCH monitoring window for DCI format 2_6;

FIGS. 12A and 12B are schematic block diagrams illustrating one embodiment of a DRX-Config information element (“IE”);

FIG. 13 is a schematic block diagram illustrating one embodiment of a DCP configuration; and

FIG. 14 is a flow chart diagram illustrating one embodiment of a method for determining a monitoring window for control information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

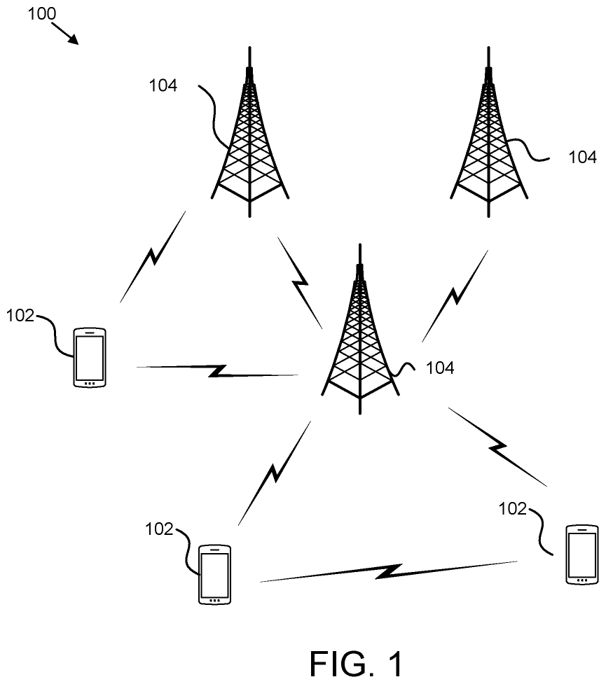

FIG. 1 depicts an embodiment of a wireless communication system 100 for determining a monitoring window for control information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a DRX configuration for a set of non-uniform DRX cycles. The set of non-uniform DRX cycles occurs according to a pattern that periodically repeats, and at least two DRX cycles of the set of non-uniform DRX cycles have different durations. In some embodiments, the remote unit 102 may determine a first set of DRX cycles based on the DRX configuration. In certain embodiments, the remote unit 102 may receive a search space configuration associated with monitoring a DCI format. The DCI format is to be monitored for a PDCCH monitoring window of time outside of an active time of a DRX cycle. In various embodiments, the remote unit 102 may receive a DCP configuration for monitoring the DCI format. In some embodiments, the remote unit 102 may determine a PDCCH monitoring window for the DCI format for each DRX cycle of the first set of DRX cycles. The PDCCH monitoring window for each DRX cycle is determined based on: a periodicity of the search space configuration, an offset of the search space configuration (e.g., wherein the offset is defined with respect to a frame boundary), or a combination thereof (e.g., wherein the search space periodicity and offset determine periodic occurrences of the search space in time); a start of an on-duration timer for the corresponding DRX cycle; the DCP configuration; or a combination thereof. The at least two DRX cycles of the first set of DRX cycles have different attributes for the PDCCH monitoring window, and the attributes comprise a window duration, a relative window location with respect to a start of a DRX on-duration, or a combination thereof. Accordingly, the remote unit 102 may be used for determining a monitoring window for control information.

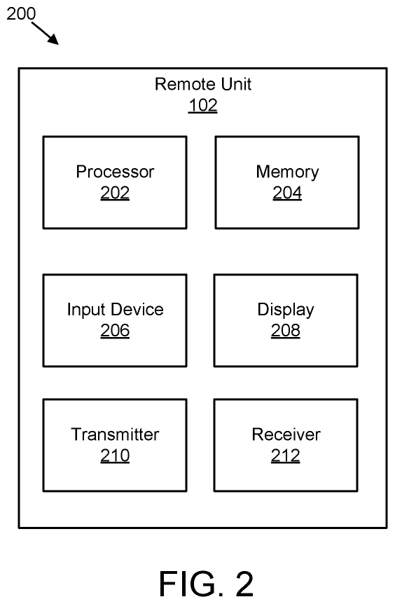

FIG. 2 depicts one embodiment of an apparatus 200 that may be used for determining a monitoring window for control information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the remote unit 102 to: receive a DRX configuration for a set of non-uniform DRX cycles, wherein the set of non-uniform DRX cycles occurs according to a pattern that periodically repeats, and at least two DRX cycles of the set of non-uniform DRX cycles have different durations; determine a first set of DRX cycles based on the DRX configuration; receive a search space configuration associated with monitoring a DCI format, wherein DCI of the DCI format is to be monitored for a PDCCH monitoring window of time outside of an active time of a DRX cycle; receive DCP configuration for monitoring the DCI format; and determine a PDCCH monitoring window for the DCI format for each DRX cycle of the first set of DRX cycles. The PDCCH monitoring window for each DRX cycle is determined based on: a periodicity of the search space configuration, an offset of the search space configuration, or a combination thereof, a start of an on-duration timer for the corresponding DRX cycle; the DCP configuration; or a combination thereof. The at least two DRX cycles of the first set of DRX cycles have different attributes for the PDCCH monitoring window, and the attributes include a window duration, a relative window location with respect to a start of a DRX on-duration, or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

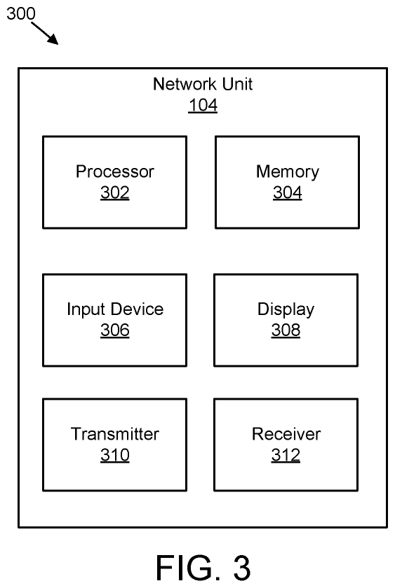

FIG. 3 depicts one embodiment of an apparatus 300 that may be used for determining a monitoring window for control information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, end-user extended reality (“XR”) devices may be expected to be power limited. Connected (“C”) discontinuous reception (“DRX”) (“C-DRX”) may be used to help such XR devices save power, and therefore may operate longer without needing to be charged (or recharged). However, XR traffic characteristics, such as non-integer traffic periodicity and jitter can result in missing an opportunity to schedule an XR video frame within an on-duration time of a DRX cycle. For instance, the video frame may arrive after the on-duration, and, therefore, needs to be scheduled in the next DRX cycle which in turn increases the associated latency. Such latency increase may not be desirable as XR packets need to be delivered within a delay budget, otherwise they may be useless.

In some embodiments, there may be ways to reduce the possibility of XR packets waiting outside DRX active time to be scheduled, including: 1) a pseudo-periodic and/or non-uniform DRX pattern intending to align DRX on-durations with nominal XR traffic arrival times based on XR video frame per second; 2) dynamically adapting DRX parameters such as C-DRX cycle, drx-on duration, drx-inactivity timer, start of drx-on duration timer, and so forth; and 3) multiple C-DRX configurations being active at the same time.

In various embodiments, downlink control information (“DCI”) (e.g., with DCI format 2_6 also referred to as a wake-up signal (“WUS”)) is monitored according to certain physical downlink control channel (“PDCCH”) monitoring parameters and conditions outside DRX active time and is used to indicate whether a user equipment (“UE”) should skip PDCCH processing during an upcoming DRX on-duration.

Described herein are PDCCH monitoring parameters and conditions for monitoring a WUS outside an active time for a non-uniform DRX pattern.

In certain embodiments, PDCCH monitoring is not aligned with a non-uniform DRX pattern. In other words, a search space set corresponding to WUS monitoring is monitored periodically and not monitored based on a non-uniform pattern. This is motivated by assigning a low priority to PDCCH monitoring alignment with XR traffic arrival in 3GPP. In addition, keeping periodic search space sets as opposed to having search space sets following a pattern may simplify PDCCH candidate counting and a search space set dropping procedure. In some embodiments herein, rules and signaling help a UE use all possible parts of the search space allowed by DCI with cyclic redundancy check (“CRC”) scrambled by a power saving (“PS”) radio network temporary identifier (“RNTI”) (“PS-RNTI”) (“DCP”) configuration for PDCCH monitoring for DRX cycles with different relative shifts with respect to the search space.

In various embodiments, XR is an umbrella term for different types of realities including:
1) virtual reality (“VR”) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (“HMD”) to completely replace the user's field of view with a simulated visual component, and to wear headphones to provide the user with the accompanying audio. Some form of head and motion tracking of the user in VR is usually also necessary to allow the simulated visual and audio components to be updated to ensure that, from the user's perspective, items and sound sources remain consistent with the user's movements. Additional means to interact with the virtual reality simulation may be provided but are not strictly necessary;
2) augmented reality (“AR”) is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed;
3) mixed reality (“MR”) is an advanced form of AR where some virtual elements are inserted into the physical scene with the intent to provide the illusion that these elements are part of the real scene; and
4) XR refers to all real-and-virtual combined environments and human-machine interactions generated by computer technology and wearables. It includes representative forms such as AR, MR, and VR and the areas interpolated among them. The levels of virtuality range from partially sensory inputs to fully immersive VR. A key aspect of XR is the extension of human experiences especially relating to the senses of existence (e.g., represented by VR) and the acquisition of cognition (e.g., represented by AR).

In certain embodiments, many of the XR and cloud gaming (“CG”) use cases are characterized by quasi-periodic traffic (e.g., with possible jitter) with a high data rate in downlink (“DL”) (e.g., video steam) combined with the frequent uplink (“UL”) (e.g., pose and/or control update) and/or UL video stream. Both DL and UL traffic are also characterized by a relatively strict packet delay budget (“PDB”).

In some embodiments, a set of anticipated XR and CG services has a certain variety and characteristics of the data streams (e.g., video) may change “on-the-fly”, while the services are running over NR. Therefore, additional information on the running services from higher layers, (e.g., the quality of service (“QoS”) flow association, frame-level QoS, ADU-based QoS, XR specific QoS, and so forth) may be beneficial to facilitate informed choices of radio parameters. It is clear that XR application awareness by a UE and a gNB may improve a user experience, improve the NR system capacity in supporting XR services, and reduce the UE power consumption.

In various embodiments, an application data unit (“ADU”) is a smallest unit of data that can be processed independently by an application (e.g., such as processing for handling out-of-order traffic data). A video frame can be an I-frame, P-frame, or can include I-slices and/or P-slices. I-frames and/or I-slices are more important and larger than P-frames and/or P-slices. An ADU may be one or more I-slices, P-slices, I-frame, P-frame, or a combination thereof.

In certain embodiments, a service-oriented design considering XR traffic characteristics (e.g., 1) variable packet arrival rate: packets coming at 30-120 frames and/or second with some jitter; 2) packets having variable and large packet size; 3) B/P-frames being dependent on I-frames; and 4) presence of multiple traffic and/or data flows such as pose and video scene in uplink) can enable more efficient (e.g., in terms of satisfying XR service requirements for a greater number of UEs, or in terms of UE power saving) XR service delivery.

In some embodiments, there may be a packet delay budget. The latency requirement of XR traffic in a radio access network (“RAN”) side (e.g., air interface) is modelled as packet delay budget (“PDB”). The PDB is a limited time budget for a packet to be transmitted over the air from a gNB to a UE. For a given packet, the delay of the packet incurred in air interface is measured from the time that the packet arrives at the gNB to the time that it is successfully transferred to the UE. If the delay is larger than a given PDB for the packet, then the packet is said to violate PDB, otherwise the packet is said to be successfully delivered. A value of PDB may vary for different applications and traffic types, which can be 10-20 ms depending on the application.

In various embodiments, a 5G arrival time of data bursts on the downlink can be quasi periodic (e.g., periodic with jitter). Some of the factors leading to jitter in burst arrival include varying server render time, encoder time, real-time transport protocol (“RTP”) packetization time, link between server and 5G gateway, and so forth. There may be a 3GPP agreed simulation assumptions for XR evaluation model DL traffic arrival jitter using truncated Gaussian distribution with mean: 0 ms, std. dev: 2 ms, range: [−4 ms, 4 ms](baseline), [−5 ms, 5 ms](optional).

In certain embodiments, applications can have a certain delay requirement on an ADU, that may not be adequately translated into packet delay budget requirements. For example, if the ADU delay budget (“ADB”) is 10 ms, then the PDB can be set to 10 ms only if all packets of the ADU arrive at the 5G system at the same time. If the packets are spread out, then ADU delay budget is measured either in terms of the arrival of the first packet of the ADU or the last packet of the ADU. In either case, a given ADB will result in different PDB requirements on different packets of the ADU. It is observed that specifying the ADB to the 5G system can be beneficial.

In some embodiments, there may be delay-aware communication.

In various embodiments, if a scheduler and/or a UE is aware of delay budgets for a packet and/or ADU, a gNB may take this knowledge into account in scheduling transmissions (e.g., by giving priority to transmissions close to their delay budget limit), and by not scheduling (e.g., UL) transmissions. The UE can also take advantage of such knowledge to determine: 1) if an UL transmission (e.g., physical uplink control channel (“PUCCH”) in response to physical downlink shared channel (“PDSCH”), UL pose, or physical uplink shared channel (“PUSCH”)) corresponding to a transmission that exceeds its delay budget can be dropped (e.g., additionally, no need to wait for re-transmission of a PDSCH and no need to keep the erroneously received PDSCH in buffer for soft combining with a re-transmission that never occurs); or 2) how much of its channel occupancy time for using unlicensed spectrum can be shared with the gNB.

In certain embodiments, a remaining delay budget may be: 1) for a DL transmission and may be indicated to a UE in DCI (e.g., for a packet of a video frame, slice, and/or ADU or a PDU-set) or via a medium access control (“MAC”) control element (“CE”) (“MAC-CE”) (e.g., for an ADU, video frame, and/or slice); and 2) for an UL transmission and may be indicated to the gNB via an UL transmission such as uplink control information (“UCI”), PUSCH transmission, and so forth.

In some embodiments, there may be application awareness at a RAN. ADU-related QoS aspects of XR may be conveyed to the RAN to optimize the communication such as ADU error rate (“AER”), ADB, and ADU content policy (e.g., referred to as ADP, which is a percentage of packets/bits of an ADU to be received in order to correctly decode the ADU).

In various embodiments, there may be jitter aspects of XR. In such embodiments, a packet arrival rate is determined by a frame generation rate (e.g., 60 frames per second (“fps”)). Accordingly, the average packet arrival periodicity is given by the inverse of the frame rate (e.g., 16.6667 ms=1/60 fps). The periodic arrival without jitter gives the arrival time at a gNB for packet with index k (=1,2,3 . . . ) as k/F*1000 ms, where F is the given frame generation rates (e.g., per second). It should be noted that this periodic packet arrival implicitly assumes fixed delay contributed from a network side including fixed video encoding time, fixed network transfer delay, and so forth.

In certain embodiments, such as in a real system, a varying frame encoding delay and network transfer time introduces jitter in packet arrival time at a gNB. In such embodiments, the jitter is modelled as a random variable added on top of periodic arrivals. The jitter follows truncated Gaussian distribution with following statistical parameters shown in Table 1.

TABLE 1
Statistical parameters for jitter

| | | Baseline value | Optional value |
|---|---|---|---|
| Parameter | unit | for evaluation | for evaluation |
| Mean | ms | 0 | |
| Standard | ms | 2 | |
| deviation | | | |
| (“STD”) | | | |
| Truncation range | ms | [−4, 4] | [−5, 5] |

It should be noted that given parameter values and considered frame generation rates (60 or 120 in this model) may ensure that packet arrivals are in order (e.g., arrival time of a next packet is always larger than that of the previous packet).

Thus, the periodic arrival with jitter gives the arrival time for packet with index k (=1,2,3 . . . ) as: offset+k/F*1000+J [ms], where F is the given frame generation rates (per second) and J is a random variable capturing jitter. It should be noted that actual traffic arrival timing of traffic for each UE could be shifted by the UE specific arbitrary offset.

In various embodiments, there may be a connected mode DRX (“C-DRX”) which is a useful tool for device energy saving. C-DRX provides two levels of PDCCH monitoring granularity via the short and long DRX configurations. It allows the device to only monitor scheduling messages during well-defined monitoring intervals (e.g., during 10 ms on-durations once every 160 ms in long DRX). The rest of the time the device can remain in sleep mode. DRX functionality controls a UE's PDCCH monitoring activity for a MAC entity resulting in discontinuously monitoring PDCCH.

In certain embodiments, there may be radio resource control (“RRC”) signaling that controls DRX operation by configuring the following parameters: 1) drx-onDurationTimer: the duration at the beginning of a DRX cycle (e.g., PDCCH is monitored within the on-duration); 2) drx-SlotOffset: the delay before starting the drx-onDurationTimer (e.g., with respect to a subframe boundary); 3) drx-InactivityTimer: the duration after the PDCCH occasion in which a PDCCH (e.g., received within DRX active time) indicates a new UL or DL transmission for the MAC entity; 4) drx-RetransmissionTimerDL (e.g., per DL hybrid automatic repeat request (“HARQ”) process except for the broadcast process): the maximum duration until a DL retransmission is received; 5) drx-RetransmissionTimerUL (per UL HARQ process): the maximum duration until a grant for UL retransmission is received; 5) drx-Long CycleStartOffset: the Long DRX cycle and drx-StartOffset which defines the subframe where the Long and Short DRX cycle starts; 6) drx-ShortCycle (optional): the Short DRX cycle; 7) drx-ShortCycleTimer (optional): the duration the UE shall follow the Short DRX cycle; 8) drx-HARQ-RTT-TimerDL (per DL HARQ process except for the broadcast process): the minimum duration before a DL assignment for HARQ retransmission is expected by the MAC entity; 9) drx-HARQ-RTT-TimerUL (per UL HARQ process): the minimum duration before a UL HARQ retransmission grant is expected by the MAC entity; 10) ps-Wakeup (optional): the configuration to start associated drx-onDurationTimer (after drx-SlotOffset from the beginning of the subframe) in case DCP (Downlink Control for Power saving) is monitored but not detected; 11) ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started; 12) ps-TransmitPeriodicL1-RSRP (optional): the configuration to transmit periodic CSI that is L1-RSRP on PUCCH during the time duration indicated by drx-onDurationTimer in case DCP is configured but associated drxonDurationTimer is not started; and 12) uplinkHARQ-Mode (optional): the configuration to set the HARQ mode per UL HARQ process.

In some embodiments, serving cells of a MAC entity may be configured by RRC in two DRX groups with separate DRX parameters. When RRC does not configure a secondary DRX group, there is only one DRX group and all serving cells belong to that one DRX group. When two DRX groups are configured, each serving cell is uniquely assigned to either of the two groups. The DRX parameters that are separately configured for each DRX group are: drx-onDurationTimer and drxInactivityTimer. The DRX parameters that are common to the DRX groups are: drx-SlotOffset, drxRetransmissionTimerDL, drx-RetransmissionTimerUL, drx-LongCycleStartOffset, drx-ShortCycle (optional), drxShortCycleTimer (optional), drx-HARQ-RTT-TimerDL, drx-HARQ-RTT-TimerUL, and uplinkHARQ-Mode (optional).

In various embodiments, there may be short DRX: if the short DRX cycle is used for a DRX group, and [(SFN×10)+subframe number] modulo (drx-ShortCycle)=(drx-StartOffset) modulo (drx-ShortCycle): the UE starts drx-onDurationTimer for this DRX group after drx-SlotOffset from the beginning of the subframe.

In certain embodiments, there may be long DRX: if the Long DRX cycle is used for a DRX group, and [(SFN×10)+subframe number] modulo (drx-LongCycle)=drx-StartOffset: 1) if DCP (DCI with CRC scrambled by PS-RNTI) monitoring is configured for the active DL bandwidth part (“BWP”): a) if DCP indication associated with the current DRX cycle received from lower layer indicated to start drxonDurationTimer, b) if all DCP occasions in time domain associated with the current DRX cycle occurred in Active Time considering grants/assignments/DRX Command MAC CE/Long DRX Command MAC CE received and Scheduling Request sent until 4 ms prior to startof the last DCP occasion, or during a measurement gap, or when the MAC entity monitors for a PDCCH transmission on the search space indicated by recoverySearchSpaceId of the SpCell identified by the cell (“C”) radio network temporary identifier (“RNTI”) (“C-RNTI”) while the ra-ResponseWindow is running, or c) if ps-Wakeup is configured with value true and DCP indication associated with the current DRX cycle has not been received from lower layers: start drx-onDurationTimer after drx-SlotOffset from the beginning of the subframe; 2) else: start drx-onDurationTimer for this DRX group after drx-SlotOffset from the beginning of the subframe.

In some embodiments, there may be a condition for using short DRX or long DRX: 1) if drx-InactivityTimer for a DRX group expires: a) if the short DRX cycle is configured: a1) start or restart drx-ShortCycleTimer for this DRX group in the first symbol after the expiry of drxInactivityTimer; a2) use the Short DRX cycle for this DRX group, b) else: use the Long DRX cycle for this DRX group.

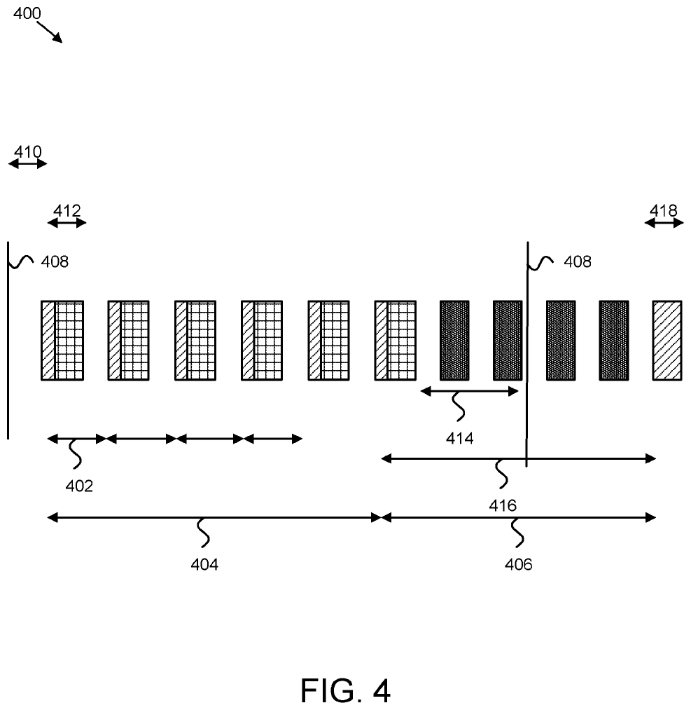

FIG. 4 is a schematic block diagram illustrating one embodiment of a system 400 for short DRX and long DRX operation. In the system 400, a UE monitors PDCCH according to short DRX and switches to long DRX once drx-ShortCycleTimer expires (e.g., no data scheduled within two short DRX cycles). Short DRX cycles 402, long DRX cycles ‘n’ 404 and ‘n+1’ 406, and subframe boundaries 408 are illustrated. Furthermore, the system 400 includes a drx-SlotOffset 410, a drx-InactivityTimer 412, a drx-ShortCycleTimer 414, a drx-ShortCycleTimer expires 416, and a DRX on duration 418.

In various embodiments, there may be a wakeup signal (“WUS”). A WUS (e.g., a DCI with DCI format 2-6) may be transmitted to a device ahead of an ON-duration if the network intends to schedule the device in that ON-duration. Thus, if the device does not detect the WUS during a monitoring occasion (“MO”), it can skip the upcoming PDCCH monitoring.

For monitoring WUS, a UE may be configured with a DCP configuration. The configuration includes: ps-Offset in which the start of the search-time of DCI format 2-6 with CRC scrambled by PS-RNTI relative to the start of the drx-onDurationTimer of long DRX with a value in multiples of 0.125 milliseconds (“ms”). 1 corresponds to 0.125 ms, 2 corresponds to 0.25 ms, 3 corresponds to 0.375 ms, and so on. The ps-Offset indicates a time where the UE starts monitoring PDCCH for detection of DCI format 2_6 according to the number of search space sets prior to a slot where the drx-onDurationTimer would start on the PCell or on the SpCell. for each search space set, the PDCCH monitoring occasions are the ones in the first Ts slots indicated by duration, or Ts=1 slot if duration is not provided, starting from the first slot of the first Ts slots and ending prior to the start of drx-onDurationTimer.

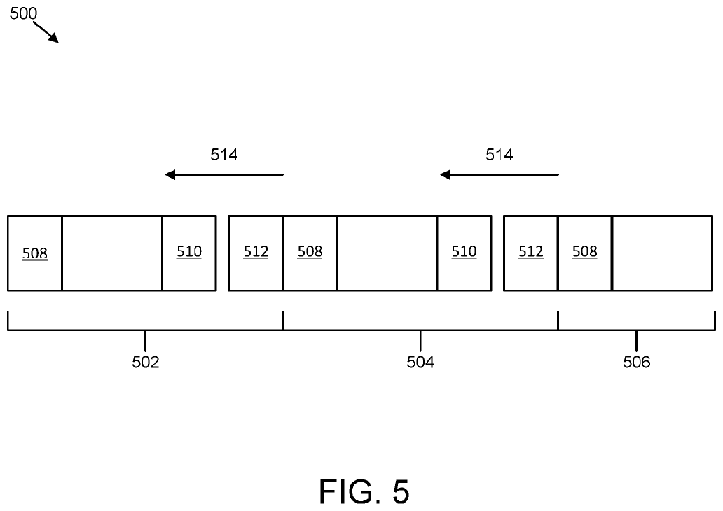

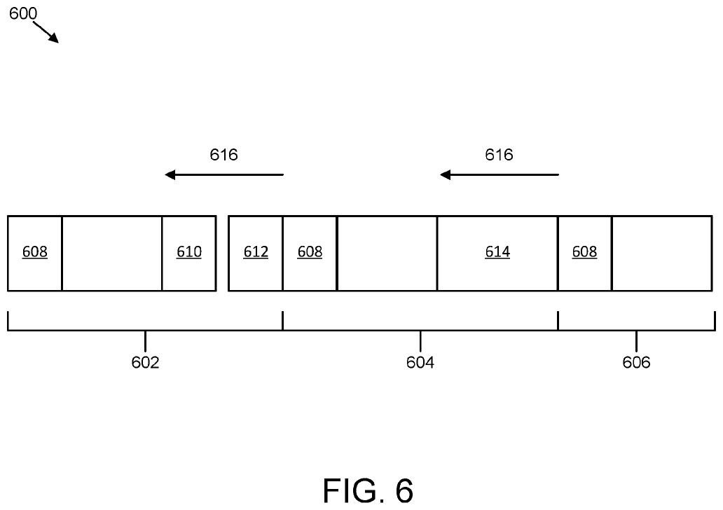

FIGS. 5 and 6 show examples of WUS monitoring prior to a DRX on-duration.

FIG. 5 is a schematic block diagram illustrating one embodiment of a system 500 for WUS monitoring within a PS-offset window according to two search space sets which contain monitoring occasions for WUS. The system 500 includes along DRX cycle #1 502 (32 ms), along DRX cycle #2 504 (32 ms), and a long DRX cycle #3 506 (32 ms). Moreover, the system 500 illustrates an on-duration 508, a first search space set 510 (SS1), and a second search space set 512 (SS2). A PS-Offset 514 is further illustrated.

FIG. 6 is a schematic block diagram illustrating one embodiment of a system 600 for WUS monitoring for long DRX cycle #2 within PS-offset window according to two search space sets which contain monitoring occasions for WUS, and for long DRX cycle #2 within PS-offset window according to one search space set which contains monitoring occasions for WUS. The system 600 includes a long DRX cycle #1 602 (32 ms), a long DRX cycle #2 604 (32 ms), and a long DRX cycle #3 606 (32 ms). Moreover, the system 600 illustrates an on-duration 608, a first search space set 610 (SS1), a second search space set 612 (SS2), and a third search space set 614 (SS3). A PS-Offset 616 is further illustrated.

In certain embodiments, a UE does not monitor PDCCH for detecting DCI format 26 during active time. If a UE reports for an active DL BWP a MinTimeGap value that is X slots prior to the beginning of a slot where the UE would start the drx-onDurationTimer, the UE is not required to monitor PDCCH for detection of DCI format 2_6 during the X slots, where X corresponds to the MinTimeGap value of the subcarrier spacing (“SCS”) of the active DL BWP.

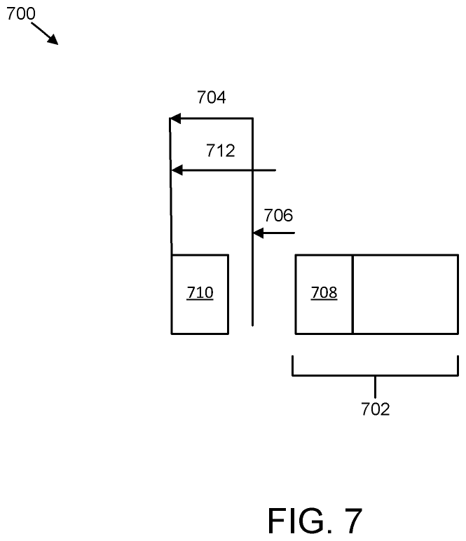

FIG. 7 is a schematic block diagram illustrating one embodiment of a system 700 in which a MinTimeGap shortens the PDCCH monitoring window prior to a DRX on-duration. The system includes a long DRX cycle 702 and a monitoring window 704. There is a MinTimeGap 706 between the long DRX cycle 702 and the monitoring window 704. The long DRX cycle 702 includes an on-duration 708. A first search space set 710 (SS1) (32 ms) is in the monitoring window 704. Further, a PS-Offset 712 is illustrated.

In certain embodiments, there may be a non-uniform DRX pattern. NR supports integer C-DRX cycles (e.g., 16 ms), however, XR traffic frame inter-arrival time may not be an integer (e.g., 16.67 ms). Such a mismatch between the C-DRX cycle and the frame inter-arrival time could lead to additional power consumption. If such a mismatch is not compensated, it could lead to a significant (e.g., even more than maximum XR traffic jitter range) drift of DRX on duration after several cycles. In XR, some of the C-DRX cycle start offset and/or on-duration/inactivation timer values may be offset to reduce the additional power consumption or scheduling latency. Such adjustments may be done dynamically or semi-statically. For instance, a DRX pattern may include short DRX cycles (e.g., 16 ms, 17 ms, 17 ms), or a long DRX pattern (e.g., 33 ms, 33 ms, and 34 ms), wherein each long DRX cycle includes either one 16 ms and one 17 ms short DRX cycles or two 17 ms short DRX cycles. The long DRX pattern can repeat every 100 ms and the short DRX pattern can repeat every 50 ms.

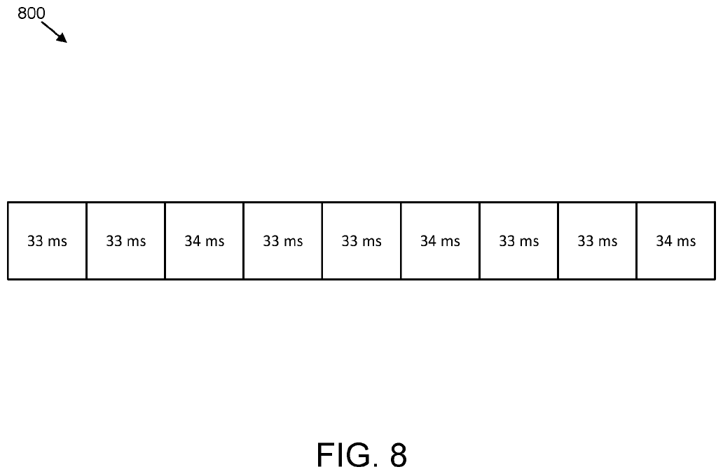

FIG. 8 is a schematic block diagram illustrating one embodiment of a system 800 in which a non-uniform DRX pattern repeats every 100 ms.

In some embodiments, there may be an alignment between PDCCH monitoring and XR traffic. In various embodiments, there may be an alignment between PDCCH monitoring and XR traffic to resolve the mismatch between PDCCH monitoring periodicity and XR traffic periodicity.

In certain embodiments, a mismatch between PDCCH monitoring periodicity and XR traffic periodicity, which is caused by non-integer XR traffic periodicity (e.g., corresponding to 60 FPS) is similar to the mismatch issue leading to non-uniform DRX pattern design. Both C-DRX and PDCCH monitoring (e.g., search space configuration) mechanisms allow a UE to periodically monitor PDCCH for some time, which is realized by configuring a cycle and/or periodicity, an offset, and an ON duration. The same solution for C-DRX enhancements may also apply to PDCCH monitoring. They can have a uniformed design.

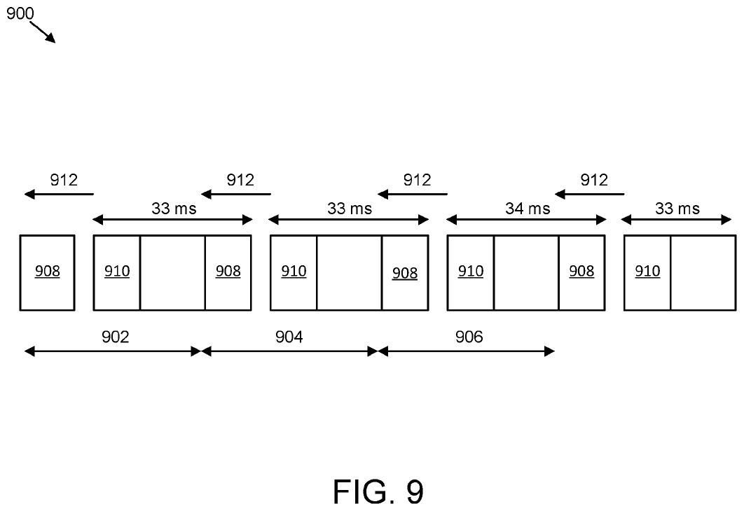

FIG. 9 is a schematic block diagram illustrating one embodiment of a system 900 in which there is non-uniform PDCCH monitoring for non-uniform DRX cycles. The system 900 illustrates a first time period 902 (33 ms), a second time period 904 (33 ms), and a third time period 906 (34 ms). A search space set 908 (SS1) and an on-duration 910 are illustrated, as well as a PS-Offset 912. The search space set 908 repeats according to a pattern of 33 ms, 33 ms, and 34 ms similar to a DRX cycle pattern. It should be noted that embodiments herein provide details of determination of a PDCCH monitoring window for WUS detection for non-uniform DRX patterns if the PDCCH is still monitored periodically (e.g., uniformly) as opposed to if PDCCH monitoring is non-uniform.

In some embodiments, there may be a WUS for indicating search space set group (“SSSG”). DCI format 2_6 may indicate SSSG to be applied at a start of an onDuration to achieve power saving gain with limited capacity loss. In particular, in various embodiments, an SSSG field may be used only if a UE should start the active time monitoring SSSG1 (e.g., the XR frame arrived before the active time and is waiting in the buffer). If the XR frame has not arrived at the moment the active time starts but expected, then indication of SSSG0 is used in DCI 2_6 and the UE goes for the default behavior of monitoring SSSG0 when the active time starts. Wherein SSSG0 and SSSG1 may respectively contain a sparser and a denser search space set group for PDCCH monitoring. It should be noted that with the applied traffic periodicity and C-DRX configuration, there may be activity expected in each onDuration.

In certain embodiments, a time window during which a UE looks for a DCI format 2_6 outside the active time is set to 4 ms. In embodiments found herein, there may be details about determination of a PDCCH monitoring window for WUS and/or DCI format 2_6 detection for a non-uniform DRX pattern, wherein the UE monitors PDCCH over a time window prior to a start of a DRX on-duration. The PDCCH monitoring may be done for WUS detection or any other purpose such as SSSG indication, and from this perspective, the mechanisms provided herein may also be applicable if the DCI format 2_6 indicates SSSG.

In various embodiments, there may be a dynamic adaptation of DRX parameters and/or configuration. In such embodiments, DCI (e.g., within DRX active time) may indicate to update one or more of C-DRX cycle, OnDurationTimer, or InactivityTimer (e.g., for the current or upcoming DRX cycle). For instance, DCI signaling within the active time of a DRX cycle may be used to indicate an update.

Embodiments herein may provide details of determination of a PDCCH monitoring window for WUS detection for a semi-statically configured non-uniform DRX pattern.

In certain embodiments, PDCCH monitoring is not aligned with a non-uniform DRX pattern. In other words, a search space set corresponding to WUS monitoring is monitored periodically and not monitored based on a non-uniform pattern. This may be motivated by assigning a low priority to PDCCH monitoring alignment with XR traffic arrival in 3GPP. In addition, keeping periodic search space sets as opposed to having search space sets following a pattern may simplify PDCCH candidate counting and search space set dropping procedure.

As used herein, WUS monitoring and DCI format 2_6 are used interchangeably, and accordingly, it only matters to monitor a DCI format prior to DRX on duration, not necessarily for detecting WUS.

In certain embodiments, there may be WUS monitoring for a non-uniform DRX pattern with uniform search space sets.

In some embodiments, there may be a configured DRX pattern either for short DRX cycles, for long DRX cycles, or both. In one example, corresponding to 60 FPS video frame arrival, a short DRX pattern of three short DRX cycles (e.g., 16 ms, 17 ms, 17 ms) repeats every 50 ms, and a long DRX pattern of three long DRX cycles (e.g., 33 ms, 33 ms, 34 ms) repeats every 100 ms.

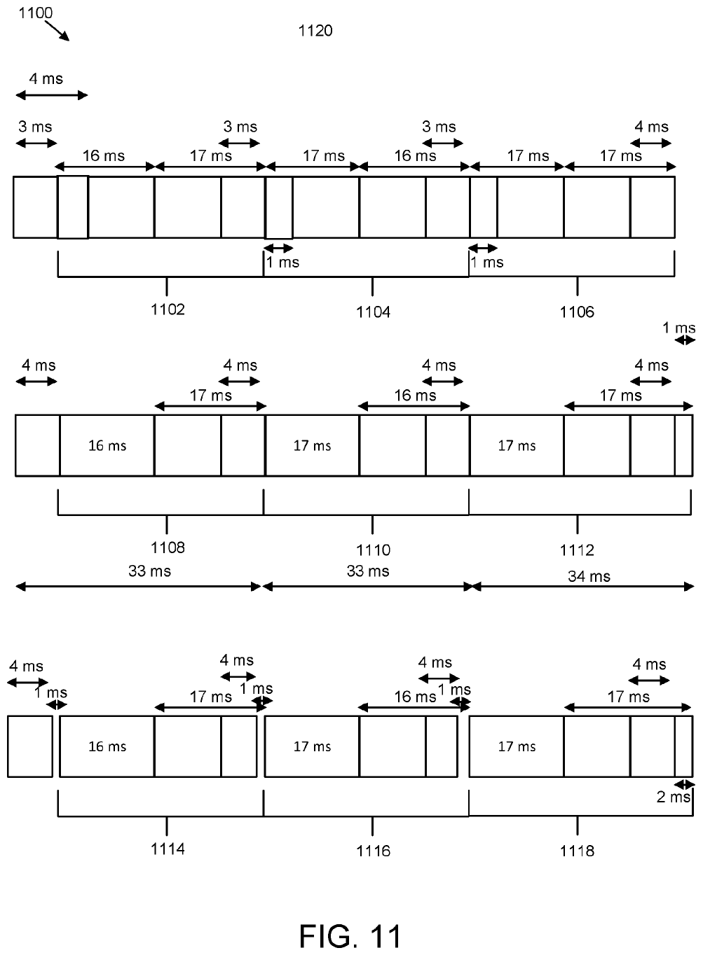

In a first scheme (e.g., scheme 0-1), there may be implementation based approaches. Assuming a duration of a search space set for WUS monitoring is at least PS_offset, a simple solution which may not need any specification change is to monitor a fraction of PS_offset as the search space set, although larger in duration than the PS-offset, only covers the fraction of the PS_offset. For an example illustrated in FIG. 11, for DRX cycle #7, only the last 3 ms prior to the start of the on-duration of DRX cycle #7 is monitored, since the last 3 ms of the search space set lies within the PS_offset=4 ms prior to the start of the on-duration, and for DRX cycle #10, only 2 ms out of 4 ms of the search space set is monitored outside active time of DRX cycle #9, which would leave less chance for the UE to get a DCI with DCI format 2_6 (or any other DCI format that is monitored outside active time of a DRX cycle within a window prior to the start of active time of the next DRX cycle), especially if the channel condition for the UE becomes weak for the last few slots and/or ms prior to the start of on-duration.

In various embodiments, a simple solution for determining a WUS monitoring window for non-uniform DRX cycles is to configure a long duration for the search space set carrying the WUS (e.g., the search space set has a duration that is PS_Offset+Delta (wherein Delta>0)) such that for all DRX cycles within a set of DRX cycles the same window of PS_offset can be monitored prior to the start of DRX on duration. Such a scheme allows the UE to monitor WUS for a monitoring window defined by ps-Offset. The cost of this approach is some of the slots do not carry any PDCCH candidates, and if the monitoring occasions in those slots cannot be used for other users or if the remaining monitoring occasions are occupied for scheduling other UEs, there may be less chance for sending DCI format 2_6 for the UE.

After some point in time, an adaptation is needed to reduce the drift between PDCCH monitoring and DRX on-duration. Such an adaptation may be changing search space monitoring offset via RRC reconfiguration or via a rule (e.g., for instance, every 400 ms, the search space offset is shifted by ‘x’ ms) or a via a dynamic signal such as DCI or MAC-CE.

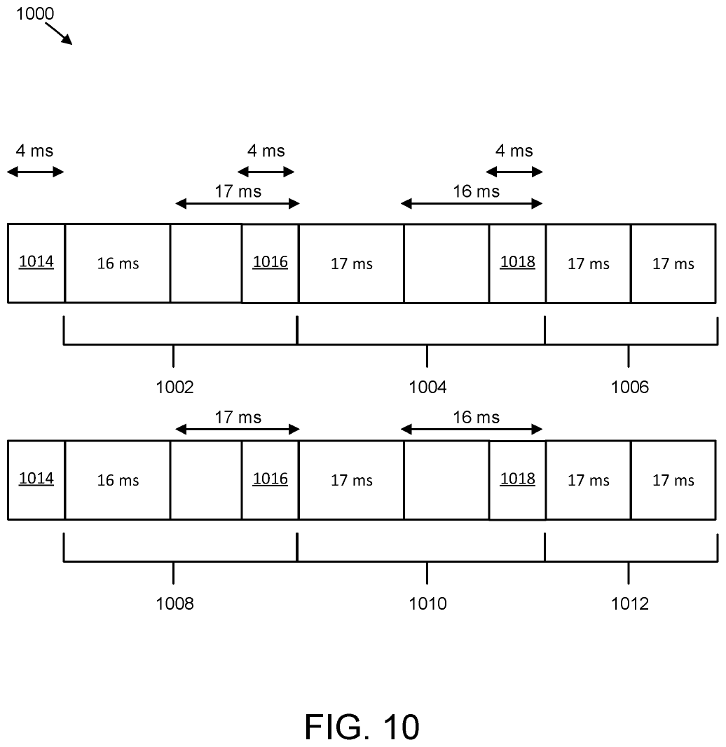

In one example, a network may configure a UE to shift a search space set for WUS monitoring by ‘x’ ms every ‘y’ ms, where ‘x’ and ‘y’ are configured when a non-uniform DRX cycle is configured or ‘x’ and ‘y’ are determined based on the non-uniform DRX cycle configuration. For instance, if a 6 ms search space duration is configured, and if ps-Offset1=4 ms, the FIG. 10 shows that a UE can determine the WUS monitoring window.

In a first scheme (e.g., scheme 1) there may be a new search space set periodicity and multiple search space sets for WUS monitoring. In certain embodiments, a simple solution to align WUS (and maybe other DCI formats) monitoring with a non-uniform DRX pattern is to use multiple search space sets with large new periodicity. For instance, for a long DRX pattern (e.g., 33, 33, 34), three search space sets, each with periodicity of 100 ms can be monitored as shown in FIG. 10.

FIG. 10 is a schematic block diagram illustrating one embodiment of a system 1000 in which WUS is monitored in three search space sets, each with new search space set periodicity of 100 ms, and duration of 4 ms. The system 1000 includes a long DRX cycle #1 1002, a long DRX cycle #2 1004, a long DRX cycle #3 1006, a long DRX cycle #4 1008, a long DRX cycle #5 1010, and a long DRX cycle #6 1012. The system 100 also includes a first search space set 1014 (SSS1), a second search space set 1016 (SSS2), and a third search space set 1018 (SSS3).

In a first embodiment, a UE determines a search space periodicity and/or overrides a configured search space periodicity based on at least one of: 1) a video frame arrival; and 2) a non-uniform DRX pattern cycle.

In a second embodiment, a UE is configured to determine a search space periodicity and/or override a configured search space periodicity based on at least one of: 1) a video frame arrival; and 2) a non-uniform DRX pattern cycle.

In some embodiments, search space set IDs which need to either follow a non-uniform pattern or follow a uniform pattern but with a new periodicity (e.g., 100 ms) compared to existing periodicities may be provided in a configuration (e.g., in the DRX configuration) or alternatively in a search space configuration, the UE may be indicated to either follow the non-uniform DRX pattern or determine a search space set periodicity according to at least one of: 1) a video frame arrival; and 2) a non-uniform DRX pattern cycle.

In various embodiments, an offset (e.g., with respect to a frame boundary) for a search space set may be determined based on a formula from 1) a configured offset (e.g., that is configured in the corresponding search space configuration); 2) a determined periodicity; 3) a non-uniform DRX pattern; or 4) a combination thereof.

In certain embodiments, a field (e.g., referred to as field 1) in a search space configuration may indicate that a search space periodicity is determined based on a non-uniform DRX pattern, such as the periodicity of occurrence of the DRX pattern (e.g., for instance, 100 ms for the case of repeating pattern of 33, 33, 34 ms long DRX cycles) or field 1 may indicate whether search space periodicity is determined based on a non-uniform DRX pattern.

In some embodiments, a UE may determine a corresponding offset for a search space based on a monitoringSlotPeriodicityAndOffset field (e.g., referred to as field 2).

Based on field 1, the UE determines whether field 2 indicates both the periodicity and offset for the search space set or only the offset. In response to determining field 2 indicates only the offset, the UE determines the offset from monitoringSlotPeriodicityAndOffset field, and determines the periodicity based on the non-DRX pattern (e.g., such as periodicity of the DRX pattern). In response to determining field 2 indicating both periodicity and the offset, the UE determines the periodicity and offset from the monitoringSlotPeriodicityAndOffset field.

In a third embodiment, new values for search space periodicities and/or offsets are added to the possible set of configurable periodicities and/or offsets. For instance, values corresponding to supported DRX cycles lengths or a function of supported DRX cycle lengths are added.

For example, for non-uniform DRX cycle lengths of 33 ms and 34 ms, at least one of 33 ms and 34 ms, or a sum of 33, 33, and 34 ms value can be added, wherein the sum operation can be done over DRX cycle lengths of a non-uniform DRX pattern or essentially a periodicity of a bundle of DRX cycles. For instance, for the case of a non-uniform DRX cycle pattern of (e.g., 22, 22, 22, 22, 22, 23, 21, 23, 23) which repeats every 200 ms, a value of 200 ms is added to possible values for monitoringSlotPeriodicityAndOffset.

This approach in its simplest form requires specifying new search space monitoringSlotPeriodicityAndOffset in a search space configuration (e.g., SearchSpace). One drawback of such an approach is that it depends on the DRX cycle pattern, hence a large number of search spaces might be needed. For instance, for 90 FPS, 9 search space sets might be needed corresponding to the following short DRX cycles (e.g., 10 ms, 11 ms, 12 ms, 11 ms, 10 ms, 12 ms, 11 ms, 11 ms, 12 ms) or corresponding to the following long-drx cycles (e.g., 22, 22, 22, 22, 22, 23, 21, 23, 23) which repeats every 200 ms. Considering a total budget of 40 search space sets for the UE, such an approach might limit the number of available search space sets for other purposes.

In a second scheme (e.g., scheme 2), there may be a non-uniform WUS monitoring window determination based on an indication.

In a first embodiment of the second scheme, a UE: 1) receives and/or determines a non-uniform pattern for DRX operation according to a DRX configuration (e.g., determines a DRX pattern for long DRX cycles: e.g., 33 ms, 33 ms, 34 ms); 2) receives a DCP configuration, including: a) a first offset (e.g., ps-Offset1) wherein, for an associated long DRX cycles, the UE can start monitoring PDCCH for WUS (e.g., DCI format 2_6) detection from the first offset prior to a slot where the drx-onDurationTimer would start on the PCell or on the SpCell (e.g., the UE can monitor for WUS detection during a first WUS monitoring window); 3) determines which search space sets can carry WUS (DCI format 2_6), referred to as “S-WUS”; 4) determines a maximum WUS monitoring window length prior to a DRX cycle, referred to as “1-max”; 5) determines WUS monitoring window for each DRX cycle based on: a) search space periodicity of “S-WUS”, b) “1-max”, c) start of on-duration timer for the DRX cycle; and 5) wherein a WUS monitoring window for at least one DRX cycle is determined to have the PS_offset1 duration and ends at least a time unit (e.g., a ms) containing DL symbols (e.g., a DL slot) prior to the start of the corresponding DRX on-duration.

In an embodiment, the UE is indicated (such as via RRC configuration) to whether a full PDCCH monitoring window of PS_offset1 duration irrespective of the PDCCH monitoring window boundaries outside active time needs to be monitored for a set of DRX cycles or the PDCCH monitoring window can be shorter and the window boundaries are within PS_offset1 from the start of the drx-on duration timer (or the slot in which the DRX on-duration would be started). For instance, in FIG. 11, the UE based on the indication determines whether the PDCCH monitoring window is 4 ms or 3 ms for DRX cycle #7.

FIG. 11 shows an example in which the search space periodicity for WUS monitoring is 33 ms (e.g., a new configured value), and the search space duration is 4 ms. The value of ps-Offset1 is also 4 ms. For the first three long DRX cycles, WUS is monitored for only 3 ms prior to the start of the DRX cycle, whereas for the next three DRX cycles, WUS is monitored for 4 ms prior to the start of the DRX cycle.

FIG. 11 is a schematic block diagram illustrating one embodiment of a system 1100 for monitoring 9 DRX cycles and the corresponding PDCCH monitoring window for DCI format 2_6. The system 1100 includes a long DRX cycle #1 1102 (with duration of 33 ms and includes two short DRX cycles of 16 ms and 17 ms), a long DRX cycle #2 1104 (with duration of 33 ms and includes two short DRX cycles of 17 ms and 16 ms), a long DRX cycle #3 1106 (with duration of 34 ms and includes two short DRX cycles of 17 ms and 17 ms), a long DRX cycle #4 1108 (with duration of 33 ms and includes two short DRX cycles of 16 ms and 17 ms), a long DRX cycle #5 1110 (with duration of 33 ms and includes two short DRX cycles of 17 ms and 16 ms), a long DRX cycle #6 1112 (with duration of 34 ms and includes two short DRX cycles of 17 ms and 17 ms), a long DRX cycle #7 1114 (with duration of 33 ms and includes two short DRX cycles of 16 ms and 17 ms), a long DRX cycle #8 1116 (with duration of 33 ms and includes two short DRX cycles of 17 ms and 16 ms), and a long DRX cycle #9 1118 (with duration of 34 ms and includes two short DRX cycles of 17 ms and 17 ms).

In certain embodiments, if the search space duration is longer than ps_offset1, then an indication or a rule may be needed to determine the WUS monitoring window for each DRX cycle. In some embodiments, a UE is indicated with a reference DRX cycle index within a set of DRX cycles, and the configured ps-offset is applied to the reference DRX cycle and the WUS monitoring windows for other DRX cycles are determined based on the ps-offset for the reference DRX and the start of on-duration for each DRX cycle.

In various embodiments, a maximum allowed gap ‘G’ is indicated to a UE, and the UE determines whether to monitor WUS for the determined WUS monitoring window for a particular DRX cycle based on whether the window has started or ended before the time gap ‘G’ prior to the start of on-duration timer for the particular DRX cycle.

In a second embodiment of the second scheme, a UE: 1) receives and/or determines a non-uniform pattern for DRX operation according to a DRX configuration (e.g., UE determines a DRX pattern for long DRX cycles: e.g., 33 ms, 33 ms, 34 ms); 2) receives a DCP configuration, including a first offset (e.g., ps-Offset1), wherein, for an associated long DRX cycles, the UE can start monitoring PDCCH for WUS (e.g., DCI format 2_6) detection from the first offset prior to a slot where the drx-onDurationTimer would start on the PCell or on the SpCell (e.g., the UE can monitor for WUS detection during a first WUS monitoring window); 3) receives a mapping associated with the DRX pattern, the mapping corresponds to a particular number of long DRX cycles (e.g., 12 long DRX cycles of length 400 ms in total)—the number of long DRX cycles can be a multiple of the number of long DRX cycles within a pattern (e.g., 12 is a multiple of 3 long DRX cycles within a 33 ms, 33 ms, 34 ms long DRX cycle pattern); 4) determines a set of WUS monitoring windows associated with the DRX cycles corresponding to the mapping based on: a) the received mapping, b) the DRX pattern, c) the first offset, and d) search spaces associated with DCI format 26; and 5) monitor for WUS detection during the set of WUS monitoring windows.

In a third embodiment of the second scheme, a UE: 1) receives and/or determines a non-uniform pattern for DRX operation according to a DRX configuration; 2) receives a DCP configuration 3) the DCP configuration includes a first offset (e.g., ps-Offset1), wherein, for a first set of DRX cycles (referred to as “DS1”), the UE can start monitoring PDCCH for WUS (e.g., DCI format 2_6) detection from the first offset prior to a slot where the drx-onDurationTimer would start on the PCell or on the SpCell (e.g., the UE can monitor for WUS detection during a first time window); and 4) determines a second offset (ps-Offset2) or a second time window, wherein, for a second set of DRX cycles (referred to as “DS2”), the UE can: 1) start monitoring PDCCH for WUS (DCI format 2_6) detection from the second offset prior to a slot where the drx-onDurationTimer would start on the PCell or on the SpCell or monitor for WUS detection during the second window.

The first embodiment, the second embodiment, and the third embodiment of the second scheme may give flexibility to the network to indicate if the full 4 ms window can be used or a portion of the 4 ms window can be used for the long DRX cycle #7 1114 in FIG. 11. The offset for search space sets carrying WUS might need be shifted every ‘ShiftT’ time units (e.g., few hundred ms) by a ‘ShiftValue’ amount.

In certain embodiments, it may be possible to use a combination of the above schemes for instance (e.g., Scheme 1, and Scheme2). Instead of shifting the offset of a search space set every ‘ShiftT’ time units (e.g., few hundred ms such as every 300 ms) in scheme 2, multiple search space sets may be configured for WUS monitoring (e.g., similar to Scheme1) with a relatively large periodicity (e.g., few hundred ms) compared to the length of a long DRX cycle (e.g., 33 ms), which may strike a balance between the usage of number of search space sets and tolerating a large gap from an on-duration for a WUS monitoring window (e.g., as number of DRX cycles within the set of DRX cycles increases, the PDCCH monitoring window could drift further with respect to the start of the on-duration timer, as shown in FIG. 11).

In various embodiments, ‘1-max’ may be determined by ps-Offset1 and a MinTimeGap reported via a UE capability report. If no MinTimeGap reported, ‘1-max=ps-Offset1’.

In certain embodiments, a DCP configuration includes a mapping. For each DRX cycle of a bundle of consecutive DRX cycles, the mapping may apply. The mapping indicates at least one of the following: 1) an offset to the ps-Offset1; 2) a gap between the start of the corresponding on-duration and the end of WUS monitoring window; and 3) the start and end of WUS monitoring window for each long DRX cycle of the particular number of long DRX cycles.

In some embodiments, the DRX configuration includes anon-uniform DRX pattern (e.g., 16 ms, 17 ms, 17 ms which repeats every 50 ms).

In various embodiments, the first set of DRX cycles (“DS1”) includes the DRX cycles that are the: 1) starting DRX cycle of the non-uniform DRX pattern (e.g., DRX cycles with duration of 16 ms); 2) ending DRX cycle of the non-uniform DRX pattern (e.g., DRX cycles with duration of 17 ms); 3) DRX cycles of the non-uniform DRX pattern with the largest duration (e.g., 17 ms); and 4) DRX cycles of the non-uniform DRX pattern with the smallest duration (e.g., 16 ms).

In certain embodiments, the first set of DRX cycles (“DS1”) are determined based on the DRX configuration, such as via an index within a DRX pattern cycle (e.g., one DRX pattern cycle includes 3 DRX cycles of 16 ms, 17 ms, and 17 ms durations) is configured, and the first set of DRX cycles (referred to as “DS1”) are the ones corresponding to that index within each DRX pattern cycle. The index could be chosen amongst the DRX cycles within a DRX pattern cycle that have different durations. For instance, for DRX pattern cycle consisting of {16 ms, 17 ms, 17 ms}DRX cycles, the index is either referring to DRX cycles of 16 ms or 17 ms duration.

In some embodiments, the second offset can be: 1) configured (e.g., in DRX configuration or in DCP configuration); and 2) determined based on the first offset, the non-uniform DRX pattern, and the search space set periodicity corresponding to WUS monitoring.

In one example, there may be a nominal long DRX cycle: 32 ms, with non-uniform DRX pattern (e.g., 16 ms, 17 ms, 17 ms), an actual long DRX cycle duration may be 33 ms or 34 ms instead of 32 ms, wherein a long DRX cycle includes either a) a 16 ms short DRX cycle and a 17 ms short DRX cycle or b) two 17 ms short DRX cycles.

In various embodiments, there may be a DRX configuration. A DRX-Config IE is used to configure DRX related parameters.

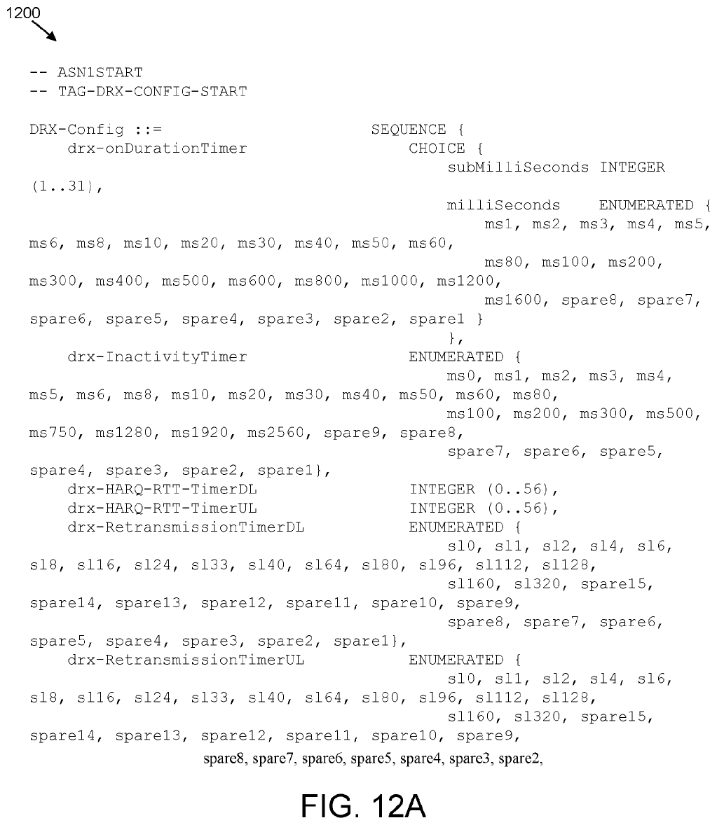

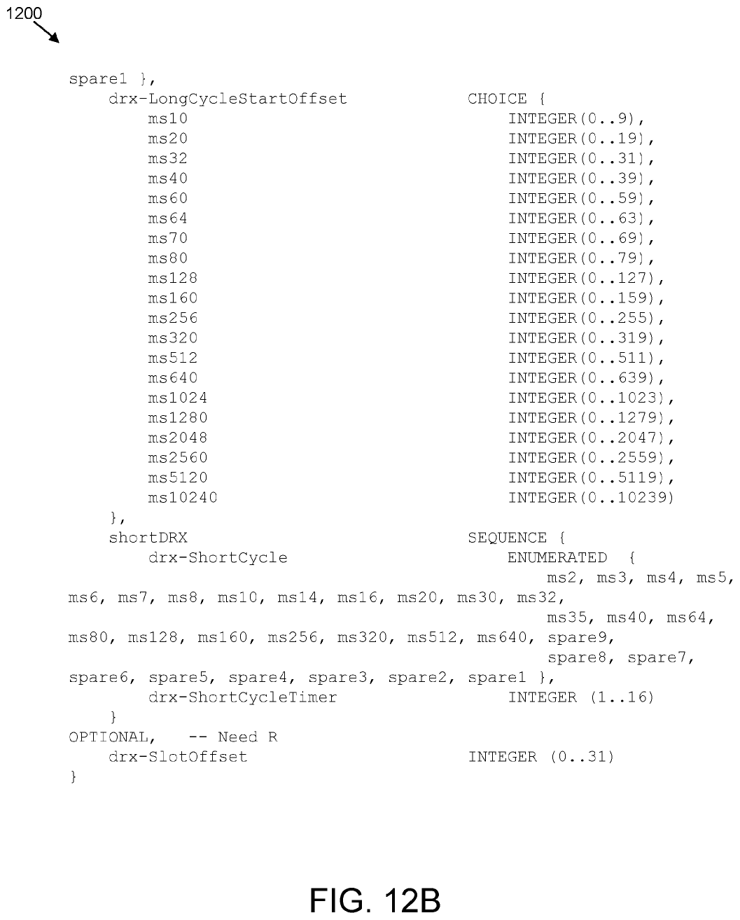

FIGS. 12A and 12B are schematic block diagrams illustrating one embodiment of a DRX-Config 1E 1200 with corresponding DRX-Config field descriptions in Table 2.

TABLE 2
DRX-Config Field Descriptions

drx-HARQ-RTT-TimerDL
Value in number of symbols of the BWP where the transport block was received.
drx-HARQ-RTT-TimerUL
Value in number of symbols of the BWP where the transport block was transmitted.
drx-InactivityTimer
Value in multiple integers of 1 ms. ms 0 corresponds to 0, ms 1 corresponds to 1 ms, ms 2
corresponds to 2 ms, and so on.
drx-LongCycleStartOffset
drx-LongCycle in ms and drx-StartOffset in multiples of 1 ms. If drx-ShortCycle is configured,
the value of drx-LongCycle shall be a multiple of the drx-ShortCycle value.
drx-onDurationTimer
Value in multiples of 1/32 ms (subMilliSeconds) or in ms (milliSecond). For the latter, value ms 1
corresponds to 1 ms, value ms 2 corresponds to 2 ms, and so on.
drx-RetransmissionTimerDL
Value in number of slot lengths of the BWP where the transport block was received. value sl0
corresponds to 0 slots, sl1 corresponds to 1 slot, sl2 corresponds to 2 slots, and so on.
drx-RetransmissionTimerUL
Value in number of slot lengths of the BWP where the transport block was transmitted. sl0
corresponds to 0 slots, sl1 corresponds to 1 slot, sl2 corresponds to 2 slots, and so on.
drx-ShortCycleTimer
Value in multiples of drx-ShortCycle. A value of 1 corresponds to drx-ShortCycle, a value of 2
corresponds to 2 * drx-ShortCycle and so on.
drx-ShortCycle
Value in ms. ms 1 corresponds to 1 ms, ms 2 corresponds to 2 ms, and so on.
drx-SlotOffset
Value in 1/32 ms. Value 0 corresponds to 0 ms, value 1 corresponds to 1/32 ms, value 2
corresponds to 2/32 ms, and so on.

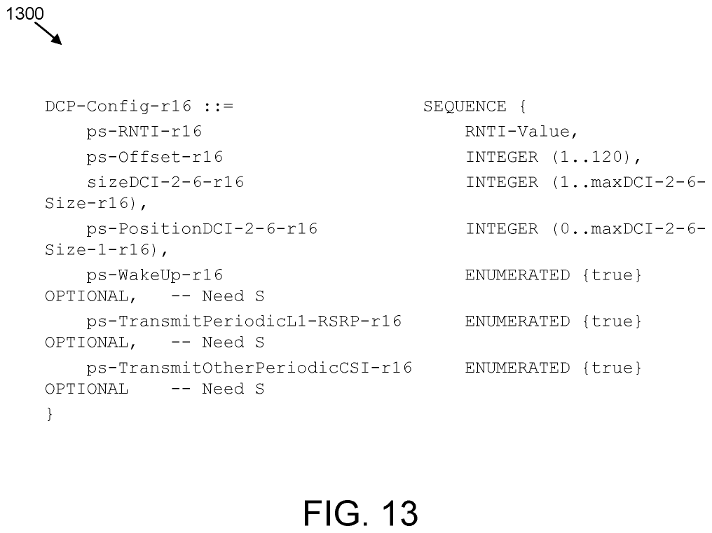

FIG. 13 is a schematic block diagram illustrating one embodiment of a DCP configuration 1300 with values defined in Table 3.

TABLE 3
ps-RNTI
RNTI value for scrambling CRC of DCI format 2-6 used for power saving.
ps-Offset
The start of the search-time of DCI format 2-6 with CRC scrambled by PS-RNTI relative to the
start of the drx-onDurationTimer of Long DRX. Value in multiples of 0.125 ms (milliseconds). 1
corresponds to 0.125 ms, 2 corresponds to 0.25 ms, 3 corresponds to 0.375 ms and so on.
ps-WakeUp
Indicates the UE to wake-up if DCI format 2-6 is not detected outside active time. If the field is
absent, the UE does not wake-up if DCI format 2-6 is not detected outside active time.
ps-PositionDCI-2-6
Starting position of UE wakeup and SCell dormancy indication in DCI format 2-6.
ps-TransmitPeriodicL1-RSRP
Indicates the UE to transmit periodic L1-RSRP report(s) when the drx-onDurationTimer does not
start. If the field is absent, the UE does not transmit periodic L1-RSRP report(s) when the drx-
onDurationTimer does not start.
ps-TransmitOtherPeriodicCSI
Indicates the UE to transmit periodic CSI report(s) other than L1-RSRP reports when the drx-
onDurationTimer does not start. If the field is absent, the UE does not transmit periodic CSI
report(s) other than L1-RSRP reports when the drx-onDurationTimer does not start.

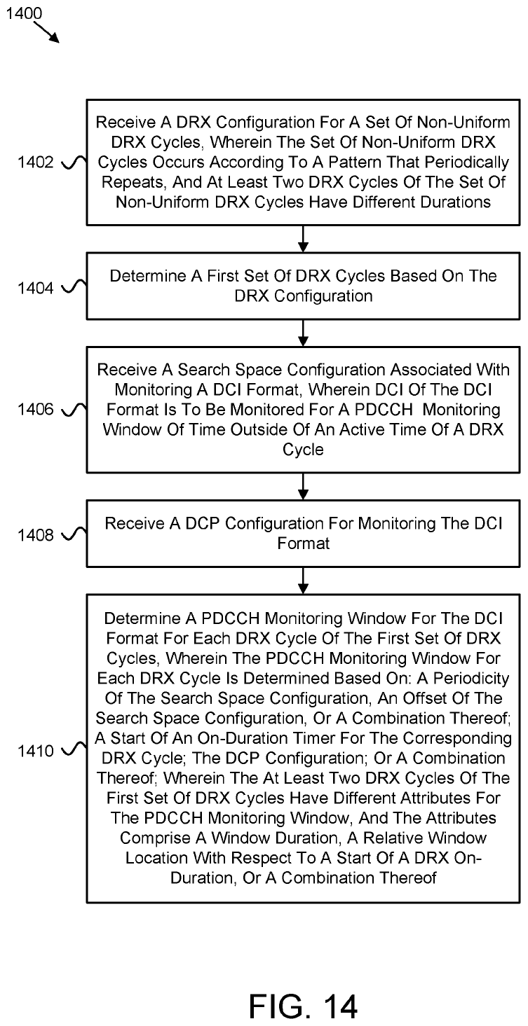

FIG. 14 is a flow chart diagram illustrating one embodiment of a method 1400 for determining a monitoring window for control information. In some embodiments, the method 1400 is performed by an apparatus, such as the remote unit 102. In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes receiving 1402 a DRX configuration for a set of non-uniform DRX cycles. The set of non-uniform DRX cycles occurs according to a pattern that periodically repeats, and at least two DRX cycles of the set of non-uniform DRX cycles have different durations. In some embodiments, the method 1400 includes determining 1404 a first set of DRX cycles based on the DRX configuration. In certain embodiments, the method 1400 includes receiving 1406 a search space configuration associated with monitoring a DCI format. DCI of the DCI format is to be monitored for a PDCCH monitoring window of time outside of an active time of a DRX cycle. In various embodiments, the method 1400 includes receiving 1408 a DCP configuration for monitoring the DCI format. In some embodiments, the method 1400 includes determining 1410 a PDCCH monitoring window for the DCI format for each DRX cycle of the first set of DRX cycles. The PDCCH monitoring window for each DRX cycle is determined based on: a periodicity of the search space configuration, an offset of the search space configuration, or a combination thereof; a start of an on-duration timer for the corresponding DRX cycle; the DCP configuration; or a combination thereof. The at least two DRX cycles of the first set of DRX cycles have different attributes for the PDCCH monitoring window, and the attributes comprise a window duration, a relative window location with respect to a start of a DRX on-duration, or a combination thereof.

In certain embodiments, the DCI format includes a wake-up indication which indicates whether the UE should monitor a PDCCH during a next DRX on-duration. In some embodiments, the DCP configuration indicates a respective shift of the PDCCH monitoring window for every DRX cycle of the first set of DRX cycles, and at least two DRX cycles of the first set of DRX cycles have different shifts. In various embodiments, the first set of DRX cycles comprises all DRX cycles of a ‘N’ of repetitions of the pattern.

In one embodiment, the PDCCH monitoring window for each DRX cycle comprises a subset of time resources corresponding to a search space set configured according to the search space configuration. In certain embodiments, a time gap between a start of a first PDCCH monitoring window for a first DRX cycle and a start of a second PDCCH monitoring window for a second DRX cycle equals a time gap between the start of the second PDCCH monitoring window for the second DRX cycle and a start of a third PDCCH monitoring window for a third DRX cycle for any three consecutive DRX cycles of the first set of DRX cycles. In some embodiments, a start of PDCCH monitoring window is periodic with a periodicity ‘P’ that is the periodicity of a reference DRX cycle of the first set of DRX cycles.

In various embodiments, the reference DRX cycle is indicated. In one embodiment, the reference DRX cycle is indicated via a RRC configuration as part of the DCP configuration or the DRX configuration. In certain embodiments, the reference DRX cycle comprises a DRX cycle with a smallest cycle duration among the first set of DRX cycles.

In some embodiments, the DCP configuration indicates a respective shift of a search space set configured according to the search space configuration and to be applied every ‘y’ time units, and each time unit comprises a slot, a ms, or a DRX cycle. In various embodiments, the set of non-uniform DRX cycles comprises three long DRX cycle durations comprising 33 ms, 33 ms, and 34 ms.

In one embodiment, the search space configuration configures a search space set for monitoring the DCI format, and the periodicity of the search space set is determined based on the pattern. In certain embodiments, the periodicity of the search space set is determined to be the periodicity of occurrence of the pattern.

In one embodiment, an apparatus for wireless communication, the apparatus comprises: a processor; and a memory coupled with the processor, the processor configured to cause the apparatus to: receive a DRX configuration for a set of non-uniform DRX cycles, wherein the set of non-uniform DRX cycles occurs according to a pattern that periodically repeats, and at least two DRX cycles of the set of non-uniform DRX cycles have different durations; determine a first set of DRX cycles based on the DRX configuration; receive a search space configuration associated with monitoring a DCI format, wherein DCI of the DCI format is to be monitored for a PDCCH monitoring window of time outside of an active time of a DRX cycle; receive DCP configuration for monitoring the DCI format; and determine a PDCCH monitoring window for the DCI format for each DRX cycle of the first set of DRX cycles, wherein the PDCCH monitoring window for each DRX cycle is determined based on: a periodicity of the search space configuration, an offset of the search space configuration, or a combination thereof, a start of an on-duration timer for the corresponding DRX cycle; the DCP configuration; or a combination thereof, wherein the at least two DRX cycles of the first set of DRX cycles have different attributes for the PDCCH monitoring window, and the attributes comprise a window duration, a relative window location with respect to a start of a DRX on-duration, or a combination thereof.

In certain embodiments, the DCI format includes a wake-up indication which indicates whether the UE should monitor a PDCCH during a next DRX on-duration.

In some embodiments, the DCP configuration indicates a respective shift of the PDCCH monitoring window for every DRX cycle of the first set of DRX cycles, and at least two DRX cycles of the first set of DRX cycles have different shifts.

In various embodiments, the first set of DRX cycles comprises all DRX cycles of a ‘N’ of repetitions of the pattern.

In one embodiment, the PDCCH monitoring window for each DRX cycle comprises a subset of time resources corresponding to a search space set configured according to the search space configuration.

In certain embodiments, a time gap between a start of a first PDCCH monitoring window for a first DRX cycle and a start of a second PDCCH monitoring window for a second DRX cycle equals a time gap between the start of the second PDCCH monitoring window for the second DRX cycle and a start of a third PDCCH monitoring window for a third DRX cycle for any three consecutive DRX cycles of the first set of DRX cycles.

In some embodiments, a start of PDCCH monitoring window is periodic with a periodicity ‘P’ that is the periodicity of a reference DRX cycle of the first set of DRX cycles.

In various embodiments, the reference DRX cycle is indicated.

In one embodiment, the reference DRX cycle is indicated via a RRC configuration as part of the DCP configuration or the DRX configuration.

In certain embodiments, the reference DRX cycle comprises a DRX cycle with a smallest cycle duration among the first set of DRX cycles.

In some embodiments, the DCP configuration indicates a respective shift of a search space set configured according to the search space configuration to be applied every ‘y’ time units, and each time unit comprises a slot, a ms, or a DRX cycle.

In various embodiments, the set of non-uniform DRX cycles comprises three long DRX cycle durations comprising 33 ms, 33 ms, and 34 ms.

In one embodiment, the search space configuration configures a search space set for monitoring the DCI format, and the periodicity of the search space set is determined based on the pattern.

In certain embodiments, the periodicity of the search space set is determined to be the periodicity of occurrence of the pattern.

In one embodiment, a method at a UE, the method comprises: receiving a DRX configuration for a set of non-uniform DRX cycles, wherein the set of non-uniform DRX cycles occurs according to a pattern that periodically repeats, and at least two DRX cycles of the set of non-uniform DRX cycles have different durations; determining a first set of DRX cycles based on the DRX configuration; receiving a search space configuration associated with monitoring a DCI format, wherein DCI of the DCI format is to be monitored for a PDCCH monitoring window of time outside of an active time of a DRX cycle; receiving a DCP configuration for monitoring the DCI format; and determining a PDCCH monitoring window for the DCI format for each DRX cycle of the first set of DRX cycles, wherein the PDCCH monitoring window for each DRX cycle is determined based on: a periodicity of the search space configuration, an offset of the search space configuration, or a combination thereof; a start of an on-duration timer for the corresponding DRX cycle; the DCP configuration; or a combination thereof; wherein the at least two DRX cycles of the first set of DRX cycles have different attributes for the PDCCH monitoring window, and the attributes comprise a window duration, a relative window location with respect to a start of a DRX on-duration, or a combination thereof.

In certain embodiments, the DCI format includes a wake-up indication which indicates whether the UE should monitor a PDCCH during a next DRX on-duration.

In some embodiments, the DCP configuration indicates a respective shift of the PDCCH monitoring window for every DRX cycle of the first set of DRX cycles, and at least two DRX cycles of the first set of DRX cycles have different shifts.

In various embodiments, the first set of DRX cycles comprises all DRX cycles of a ‘N’ of repetitions of the pattern.

In one embodiment, the PDCCH monitoring window for each DRX cycle comprises a subset of time resources corresponding to a search space set configured according to the search space configuration.

In certain embodiments, a time gap between a start of a first PDCCH monitoring window for a first DRX cycle and a start of a second PDCCH monitoring window for a second DRX cycle equals a time gap between the start of the second PDCCH monitoring window for the second DRX cycle and a start of a third PDCCH monitoring window for a third DRX cycle for any three consecutive DRX cycles of the first set of DRX cycles.

In some embodiments, a start of PDCCH monitoring window is periodic with a periodicity ‘P’ that is the periodicity of a reference DRX cycle of the first set of DRX cycles.

In various embodiments, the reference DRX cycle is indicated.

In one embodiment, the reference DRX cycle is indicated via a RRC configuration as part of the DCP configuration or the DRX configuration.

In certain embodiments, the reference DRX cycle comprises a DRX cycle with a smallest cycle duration among the first set of DRX cycles.

In some embodiments, the DCP configuration indicates a respective shift of a search space set configured according to the search space configuration and to be applied every ‘y’ time units, and each time unit comprises a slot, a ms, or a DRX cycle.

In various embodiments, the set of non-uniform DRX cycles comprises three long DRX cycle durations comprising 33 ms, 33 ms, and 34 ms.

In one embodiment, the search space configuration configures a search space set for monitoring the DCI format, and the periodicity of the search space set is determined based on the pattern.

In certain embodiments, the periodicity of the search space set is determined to be the periodicity of occurrence of the pattern.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a discontinuous reception (DRX) configuration for a set of non-uniform DRX cycles occurring according to a periodic pattern, wherein at least two DRX cycles of the set of non-uniform DRX cycles have different durations;
determine a first set of DRX cycles based on the DRX configuration;
receive a search space configuration associated with monitoring a downlink control information (DCI) format, wherein a DCI having the DCI format is to be monitored during a physical downlink control channel (PDCCH) monitoring window of time outside of an active time of a DRX cycle;
receive DCI with a cyclic redundancy check (CRC) scrambled by a power saving (PS) radio network temporary identifier (RNTI) (PS-RNTI) (DCP) configuration for monitoring the DCI format; and
determine a PDCCH monitoring window for monitoring the DCI format for each DRX cycle of the first set of DRX cycles, wherein the PDCCH monitoring window for each DRX cycle is determined based on:
a periodicity of the search space configuration, or an offset of the search space configuration, or a combination thereof;
a start of an on-duration timer for the corresponding DRX cycle; or
the DCP configuration;
or a combination thereof;
wherein the at least two DRX cycles of the first set of DRX cycles have different attributes for the PDCCH monitoring window, and the attributes comprise a window duration, or a relative window location with respect to a start of a DRX on-duration, or a combination thereof.

2. The UE of claim 1, wherein the DCI format includes a wake-up indication which indicates whether the UE should monitor a PDCCH during a next DRX on-duration.

3. The UE of claim 1, wherein the DCP configuration indicates a respective shift of the PDCCH monitoring window for every DRX cycle of the first set of DRX cycles, and at least two DRX cycles of the first set of DRX cycles have different shifts.

4. The ULE of claim 1, wherein the first set of DRX cycles comprises all DRX cycles of a number (‘N’) of repetitions of the pattern.

5. The ULE of claim 1, wherein the PDCCH monitoring window for each DRX cycle comprises a subset of time resources corresponding to a search space set configured according to the search space configuration.

6. The UE of claim 1, wherein a time gap between a start of a first PDCCH monitoring window for a first DRX cycle and a start of a second PDCCH monitoring window for a second DRX cycle equals a time gap between the start of the second PDCCH monitoring window for the second DRX cycle and a start of a third PDCCH monitoring window for a third DRX cycle for any three consecutive DRX cycles of the first set of DRX cycles.

7. The ULE of claim 1, wherein a start of PDCCH monitoring window is periodic with a periodicity ‘P’ that is the periodicity of a reference DRX cycle of the first set of DRX cycles.

8. The ULE of claim 7, wherein the reference DRX cycle is indicated.

9. The ULE of claim 8, wherein the reference DRX cycle is indicated via a radio resource control (RRC) configuration as part of the DCP configuration or the DRX configuration.

10. The ULE of claim 7, wherein the reference DRX cycle comprises a DRX cycle with a smallest cycle duration among the first set of DRX cycles.

11. The UE of claim 1, wherein the DCP configuration indicates a respective shift of a search space set configured according to the search space configuration to be applied every ‘y’ time units, and each time unit comprises a slot, a ms, or a DRX cycle.

12. The UE of claim 1, wherein the set of non-uniform DRX cycles comprises three long DRX cycle durations comprising 33 ms, 33 ms, and 34 ms.

13. The UE of claim 1, wherein the search space configuration configures a search space set for monitoring the DCI format, and the periodicity of the search space set is determined based on the pattern.

14. The UE of claim 13, wherein the periodicity of the search space set is determined to be the periodicity of occurrence of the pattern.

15. A method at a user equipment (UE), the method comprising:
receiving a discontinuous reception (DRX) configuration for a set of non-uniform DRX cycles occurring according to a periodic pattern, wherein at least two DRX cycles of the set of non-uniform DRX cycles have different durations;
determining a first set of DRX cycles based on the DRX configuration;
receiving a search space configuration associated with monitoring a downlink control information (DCI) format, wherein a DCI having the DCI format is to be monitored during a physical downlink control channel (PDCCH) monitoring window of time outside of an active time of a DRX cycle;
receiving DCI with a cyclic redundancy check (CRC) scrambled by a power saving (PS) radio network temporary identifier (RNTI) (PS-RNTI) (DCP) configuration for monitoring the DCI format; and
determining a PDCCH monitoring window for monitoring the DCI format for each DRX cycle of the first set of DRX cycles, wherein the PDCCH monitoring window for each DRX cycle is determined based on:
a periodicity of the search space configuration, or an offset of the search space configuration, or a combination thereof;
a start of an on-duration timer for the corresponding DRX cycle; or
the DCP configuration;
or a combination thereof;
wherein the at least two DRX cycles of the first set of DRX cycles have different attributes for the PDCCH monitoring window, and the attributes comprise a window duration, or a relative window location with respect to a start of a DRX on-duration, or a combination thereof.

16. The method of claim 15, wherein the DCI format includes a wake-up indication which indicates whether the UE should monitor a PDCCH during a next DRX on-duration.

17. The method of claim 15, wherein the DCP configuration indicates a respective shift of the PDCCH monitoring window for every DRX cycle of the first set of DRX cycles, and at least two DRX cycles of the first set of DRX cycles have different shifts.

18. The method of claim 15, wherein the first set of DRX cycles comprises all DRX cycles of a number (‘N’) of repetitions of the pattern.

19. The method of claim 15, wherein the PDCCH monitoring window for each DRX cycle comprises a subset of time resources corresponding to a search space set configured according to the search space configuration.

20. A processor for wireless communication, comprising:
at least one controller coupled with at least one memory and configured to cause the processor to:
receive a discontinuous reception (DRX) configuration for a set of non-uniform DRX cycles occurring according to a periodic pattern, wherein at least two DRX cycles of the set of non-uniform DRX cycles have different durations;
determine a first set of DRX cycles based on the DRX configuration;
receive a search space configuration associated with monitoring a downlink control information (DCI) format, wherein a DCI having the DCI format is to be monitored during a physical downlink control channel (PDCCH) monitoring window of time outside of an active time of a DRX cycle;
receive DCI with a cyclic redundancy check (CRC) scrambled by a power saving (PS) radio network temporary identifier (RNTI) (PS-RNTI) (DCP) configuration for monitoring the DCI format; and
determine a PDCCH monitoring window for monitoring the DCI format for each DRX cycle of the first set of DRX cycles, wherein the PDCCH monitoring window for each DRX cycle is determined based on:
a periodicity of the search space configuration, or an offset of the search space configuration, or a combination thereof;
a start of an on-duration timer for the corresponding DRX cycle; or
the DCP configuration;
or a combination thereof;
wherein the at least two DRX cycles of the first set of DRX cycles have different attributes for the PDCCH monitoring window, and the attributes comprise a window duration, or a relative window location with respect to a start of a DRX on-duration, or a combination thereof.
